(19) United States
(12) Patent Application Publication
(10) Pub. No.: US 2014/0289014 A1
(43) Pub. Date: Sep. 25, 2014

(54) METHOD AND SYSTEM TO EVALUATE CONTACTS

(71) Applicant: Vestorly, Inc., New York, NY (US)

(72) Inventors: Justin Wisz, New York, NY (US); Ralph Pahlmeyer, New York, NY (US)

(73) Assignee: Vestorly, Inc., New York, NY (US)

(21) Appl. No.: 14/213,485

(22) Filed: Mar. 14, 2014

Related U.S. Application Data
(60) Provisional application No. 61/791,866, filed on Mar. 15, 2013.

(51) Int. Cl. G06Q 30/02

(52) U.S. Cl. CPC G06Q 30/0203
USPC 705/7.32

(57) ABSTRACT

A system and method of evaluating contacts for an professional service provider is disclosed. The system may create or more network located online communities related to an professional service provider, such as an investment professional service provider. The communities may display information of interest to the members of the community. The manner a contact reaches the online community may be indicative of the level of interest of the contact. The level of interest may be classified or scored. A series of questions may be posed to the contact and the answers to those questions may also be scored or classified. By scoring or classifying the answers to a series of logically arranged questions, a contact classification or score for a contact may be created and evaluated.

### BACKGROUND

For most professional service providers, professional service providers and enterprises that support professional service providers, the more and better clients one has, the more success the professional service provider is perceived to have. In an ideal world, clients and contacts would flock to a certain professional service provider, in reality, trying to obtain communication with contacts that have interest in the services of the professional service provider and are prepared to use the services of the professional service provider is difficult. Traditional methods of finding decent contacts involving networking, such as meeting friends of friends or joining clubs where potential contacts may also belong.

Creating a similar type of networking opportunities in a virtual community has been a challenge. Trying to entice people to visit a network location is difficult. Even if people do visit the network location, it is difficult to know whether the visitor is a legitimate contact or whether the contact may be an electronic search crawler or a fake online persona. Having a way to know that a legitimately interested contacts has visited a network site would be useful.

### SUMMARY

A system and method of evaluating contacts for an professional service provider or an enterprise that supports a professional service provider is disclosed. A processor may be used to receive a sign on from a contact. The manner of which the contact signed in may be evaluated. A contact score may be adjusted based on the evaluation of the manner of which the contact signed in and at least one question may be displayed to the contact related to a purpose of the professional service provider. An answer may be received from the contact to the question. The answer from the contact to the at least one question related to the purpose of the professional service provider may be evaluated. The contact score may be adjusted based on the evaluation of the answers from the contact related to the purpose of the professional service provider. A logical follow up question based on the answer from the contact related to the purpose of the professional service provider may be determined and displayed to the contact. A follow up answer from the contact to the follow up question may be received and evaluated. The contact score may be adjusted based on the evaluation of the follow-up answer to the follow up question. The contact score may be evaluated and if the contact score is over a threshold and a notification for the professional service provider may be created.

### BRIEF DESCRIPTION OF THE DRAWINGS

FIG. 1 illustrates a method of evaluating contacts for an professional service provider;

FIGS. 2A and 2B flow through one embodiment of the method;

FIGS. 3A-3C illustrate one embodiment of scoring responses to questions and follow-up questions;

FIG. 4 illustrates elements of a sample a computing network;

FIG. 5 illustrates a computer system that implements the various embodiments of the method; and

FIG. 6 illustrates a portable computer system that implements the various embodiments of the method.

### SPECIFICATION

A system and method of evaluating contacts for an professional service provider or an enterprise that supports a professional service provider is disclosed. As networking has moved to an electronic networked environment, effective networking to obtain useful contacts has proven to be difficult. Common problems include determining whether a contact is real or fictitious, determining a level of interest of the contact and determining how to find content to interest contacts has proven to be an ongoing problem.

At a high level, the described system addresses these problems by creating one or more network located online communities related to an professional service provider, such as an investment professional service provider. The communities may display information of interest to the members of the community. A contact may be notified of an online community in a variety of ways and the manner a contact reaches the online community may be indicative of the level of interest of the contact. The level of interest may be classified or scored and stored in a file related to the contact. A series of questions may be posed to the contact and the answers to those questions may also be scored or classified. By scoring or classifying the answers to a series of logically arranged questions which may be posed over a period of time, a contact classification or score for a contact may be created and evaluated. If the classification or score is high enough, immediate communication with the contact may be appropriate and in other situations, it may be appropriate to follow up at an additional time in the future. The classifications or scores may be used to place contacts into one of a variety of categories, such as contact in three months to set up immediate meeting. Further, in some situations, the classification or score may indicate that the contact really has no interest in the professional service provider and this also may be useful as the professional service provider may stop wasting time pursuing the contact.

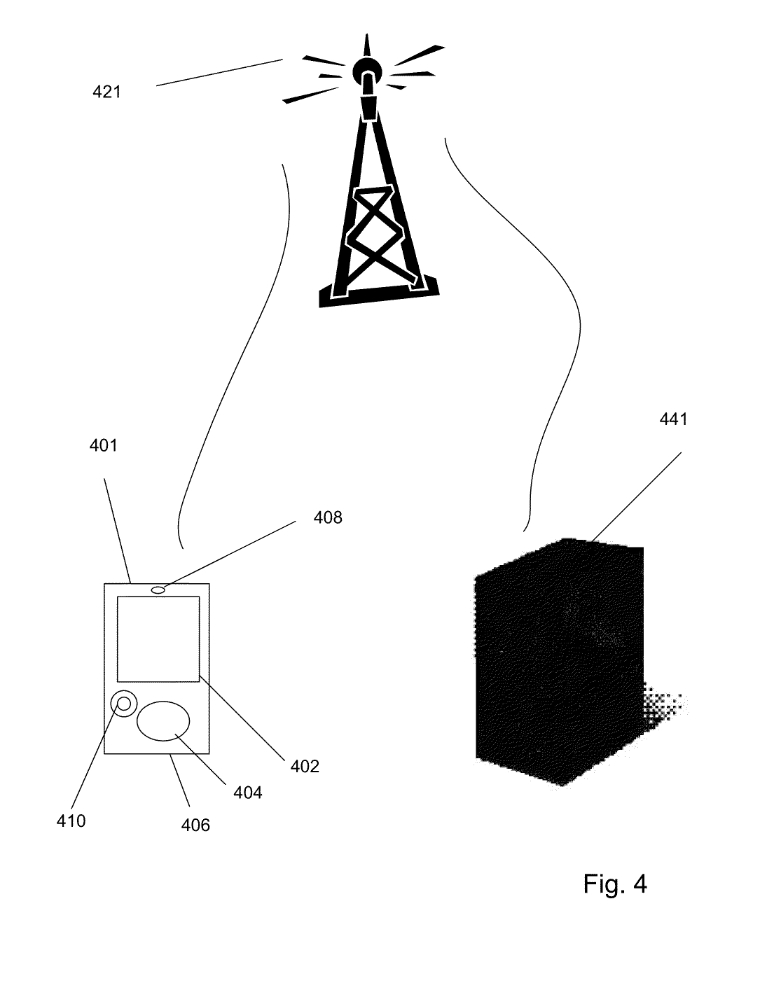

In implementation, a computing device 401 or 441 (FIG. 4) may be physically configured as a separate device to implement the blocks of the method. The device may a separate device, may be a portable computing device 401 or a server type computing device 441 or a combination of portable 401 and server computing devices 441 that operate together or as part of a cloud computing network.

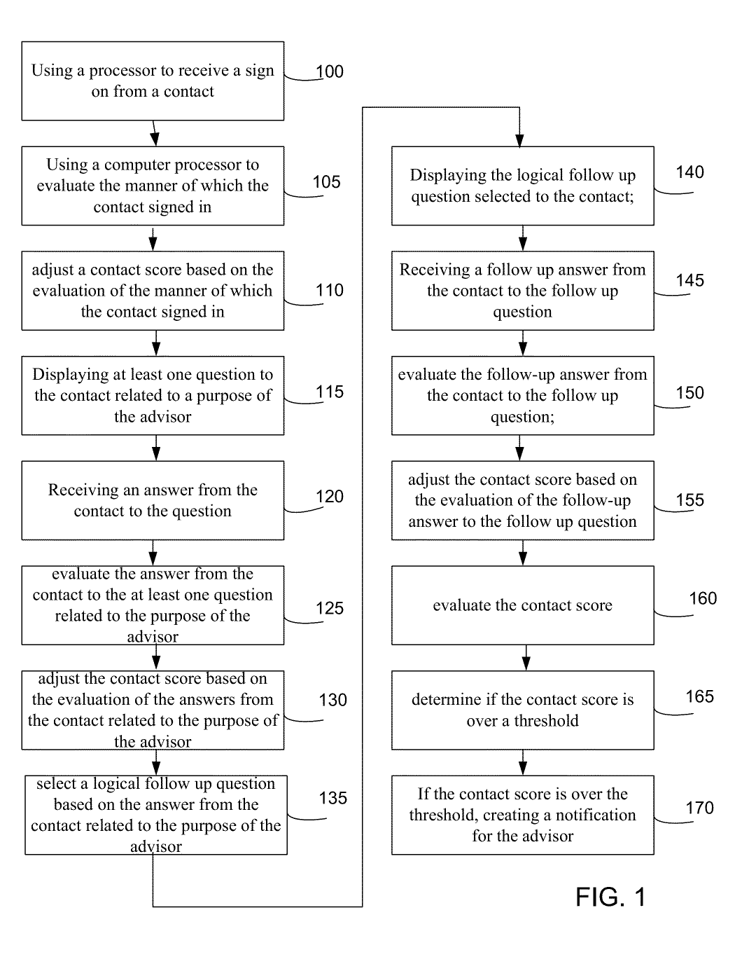

FIG. 1 may illustration a sample method that uses a processor execute a method of evaluating contacts. FIGS. 4-6 may illustrate a sample computer system and network that may be physically configured according to the blocks of the method and will be discussed further in this application. At block 100, a sign on may be received from a contact. The sign on may be an electronic series of letters and numbers that are unique to an individual on the electronic site. Common sign ons may include email addresses or other identifying letter/number combinations. Logically, sign ons may be stored and reviewed such that a single person controls each unique sign on and that a contact may proceed to the site without having to navigate through questions intended for new users. In some embodiments, passwords also may be required with the sign ons.

At block 105, a computer processor may be used to evaluate the manner of which the contact signed in. In some embodiments, the user may select to sign into the community site using technology from another site. As an example, a user may sign into LinkedIn and there may be an option to using an API to sign directly into the community web site using the sign in data from the LinkedIn site. In some embodiments, different connecting web sites may use different APIs but still may connect to the contact web site. In other embodiments, contacts may sign in following an invitation sent from a current contact, may be invited from a non-client, may be enticed to enter by viewing a content piece on the community web site or may be a pre-existing contact of the professional service provider.

It should be noted that for the purpose of enticing contacts to enter the web community, content may be on the community web site that may be of interest to the contacts. For example, if the community is directed to buying bonds, tips on bonds that are thought to be underpriced may be available. Similarly, an professional service provider may have more than one web community with each community directed to different aspects of investing. For example, a second web community may focus on underpriced stocks, a third web community may focus on small cap opportunities, etc. Of course, in some embodiments, all these communities may be collapsed into a single community that focuses on a higher level concept, such as investing in general. Also, in some embodiments, a series of professional service providers might share a community while in other embodiments, one professional service provider may have multiple communities.

The system may assist in creating the content for the professional service providers. For example, a story on the NYSE average may have applicability to a wide variety of communities. The content may be automatically forwarded from an authority to each relevant community. In some embodiments, when the community is created, areas of interest may be selected by the creator and relevant stories may be automatically forwarded. In other embodiments, the communities may be analyzed and relevant stories may be selected that are related to the content that already exists on the community. In yet another embodiment, an professional service provider may be presented a plurality of content related stories and the professional service provider may select the content to be added to one or more of his communities. Further, stories from news content services may be displayed along with comments from the professional service provider or others in the community.

At block 110, a computer processor may be used to adjust a contact score based on the evaluation of the manner of which the contact signed in. The ultimate goal of the community web site may be to obtain and identify likely customers. By scoring the contacts, more likely future customers may be sifted or sorted from more unlikely future customers. At a high level, a series of question may be posed over time to contacts and the responses may be evaluated to determine the probability that the contact may be a valuable customer to a specific professional service provider. The contacts may be evaluated and place into categories based on their responses or other data obtained about the contact.

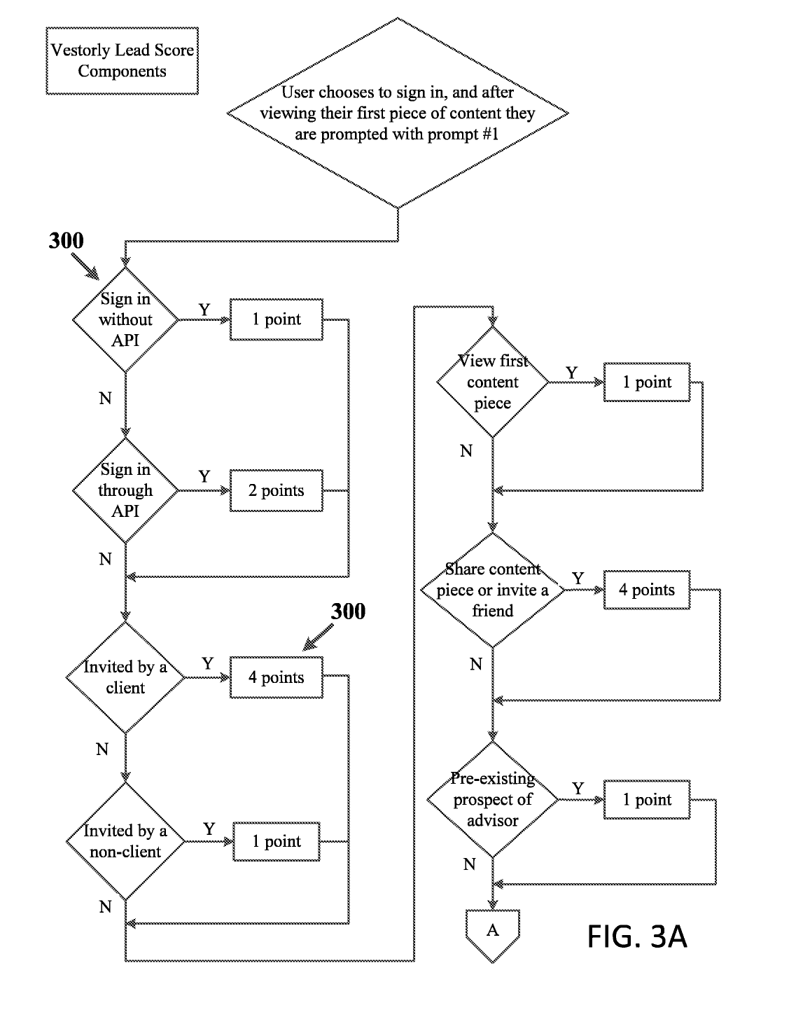

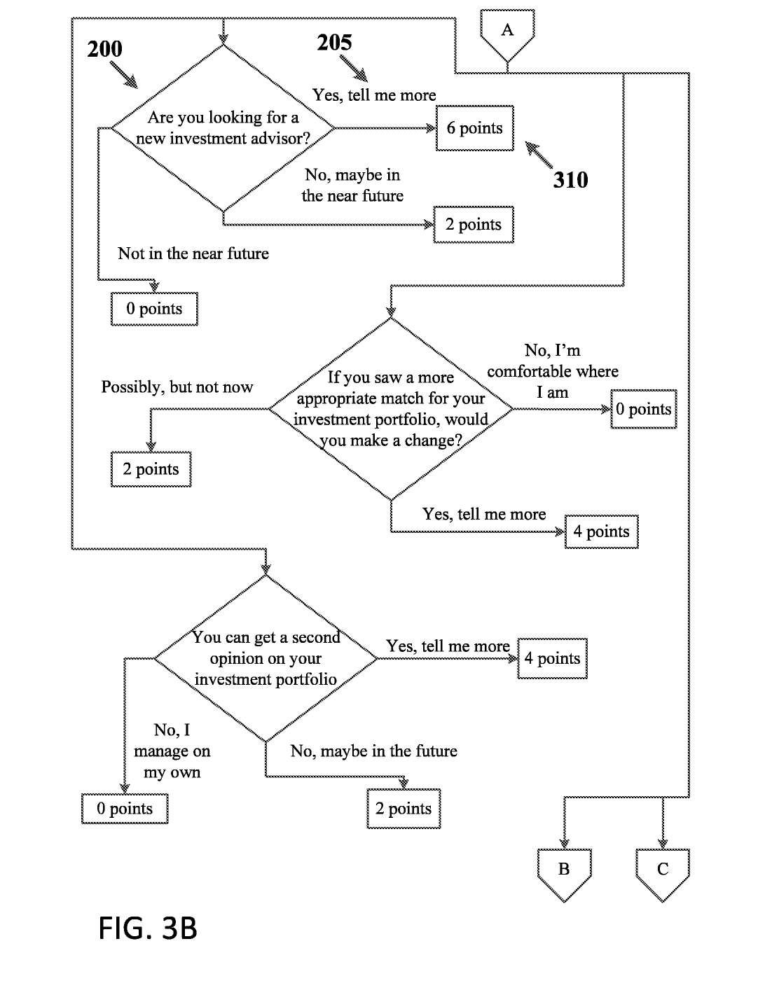

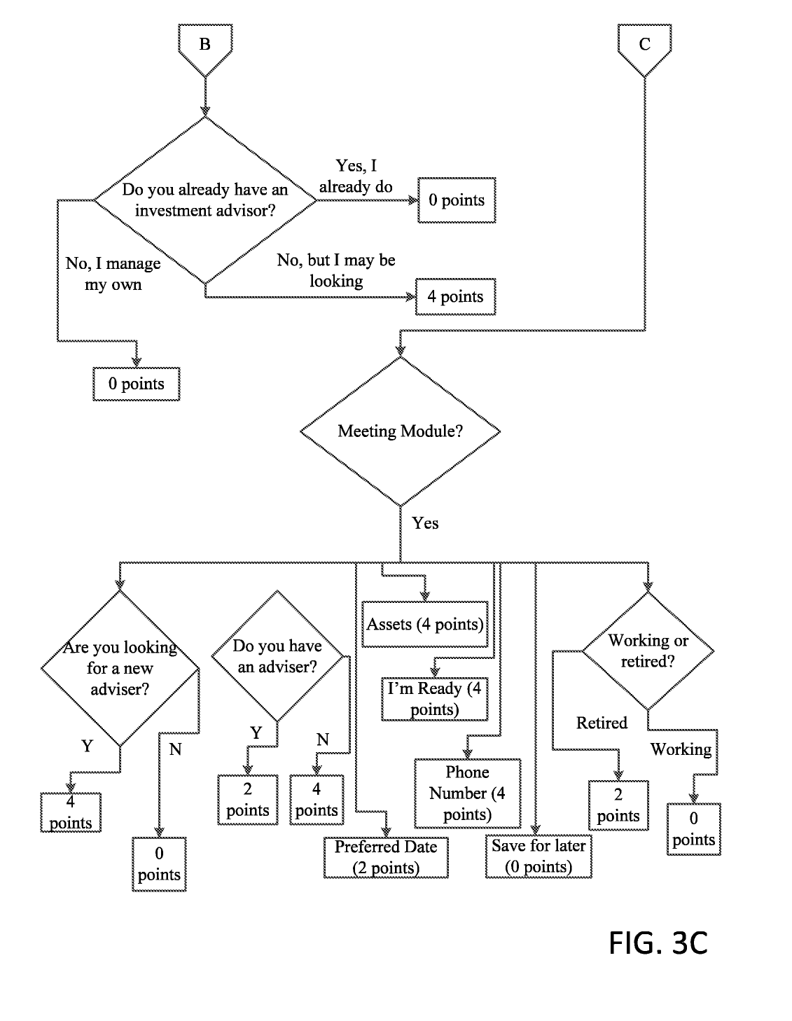

Referring to FIGS. 3A-3C, the classification or score may be adjusted upward for answers that indicate a contact is more likely to convert into a client and adjusted downward to indicate that a contact is less likely to convert into a client. For example, the community site may have articles which may be related to the purpose of the professional service provider. If an article is share by a member, logic would indicate that the contact may agree with the article and be more likely to be a customers.

Logically, every professional service provider may seek a different type of client. Thus, the questions and follow-up questions along with the possible answers may be created by the professional service provider to suit his/her own needs. For example, a first professional service provider may enjoy working with college graduates just starting their first job and the questions and answers may be related to whether a contact is a recent college graduate and whether the graduate has a job. Another professional service provider may have expertise in working with retirees and the questions may be whether a contact is retired and whether the retiree has a plan for retirement. Further, each professional service provider may create separate categories that are used to classify the contacts and there may be as many or as few classifications as the professional service provider may desire and the separation may be defined by the professional service provider.

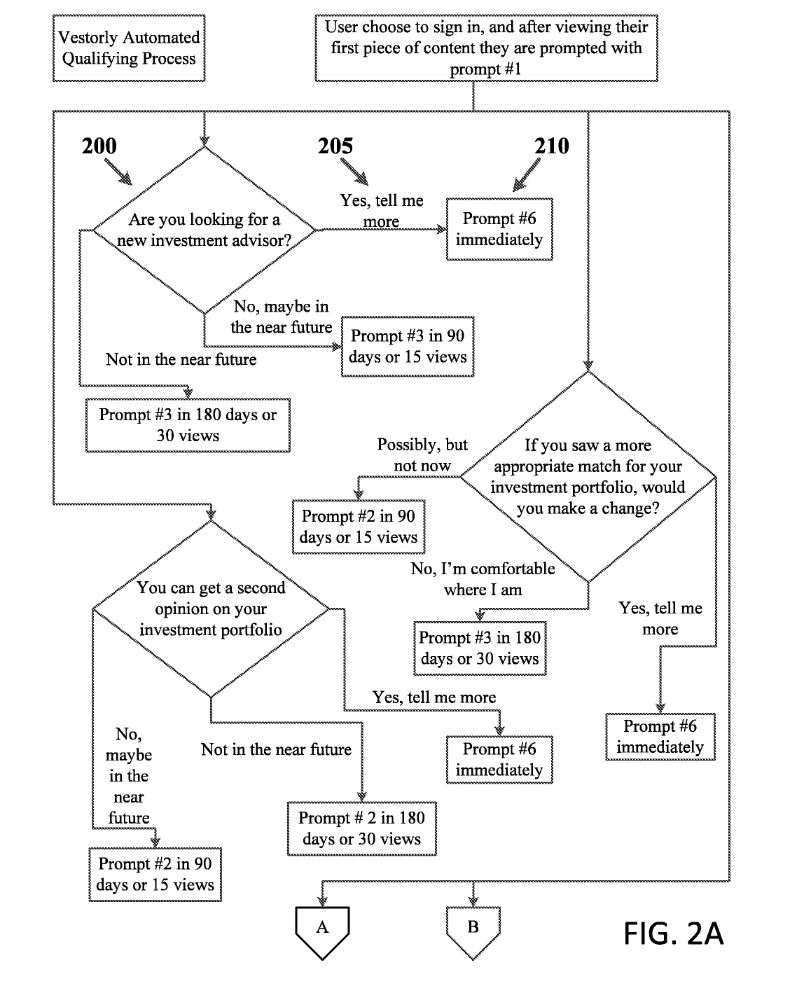

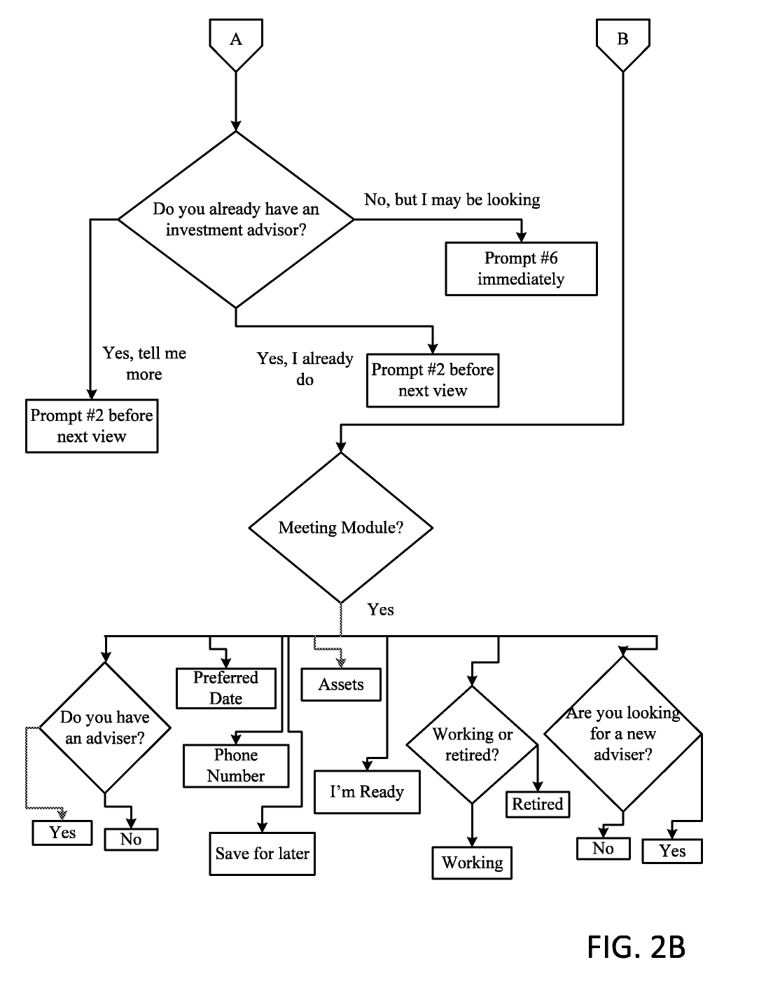

In one embodiment illustrated in FIGS. 2A and 2B, the different manners of signing on 300 the community web site may be give scores 305. For example,
whether the user signed in using an API, +2
whether the user signed in without using an API, +1
whether the user was invited by a client, +4
whether the user was invited by a non-client; +1
whether the user reviewed the first content piece, +1
whether the user shared the content piece, +4
whether the user invited a friend, +4 and
whether the user is a pre-existing prospect of the professional service provider +1.

The scoring methodology may continue throughout the visit of the contact through the web site. As the contact further explores, it may be evident that the contact is more or less interested in the services of the professional service provider and the contact score may reflect the interest level.

At block 115, at least one question 200 may be displayed to the contact related to a purpose of the professional service provider. The one question 200 to the contact may be related to a purpose of the professional service provider and may attempt to further determine how likely it is that the contact may require services from the professional service provider. As can be seen in FIGS. 2A and 2B, there are sample questions 200 and sample follow up questions 210 based on the responses 205. The questions may be designed to obtain a better handle on the needs of the contact and whether the professional service provider can help. Again, these are simply sample questions and are not meant to be limiting. Other questions specific to the professional service provider may be possible and are contemplated.

At block 120, an answer 205 from the contact to the question 200 may be received. The answer 205 may be a multiple choice answer, a true/false answer, a typed in answer, or any other appropriate answer based on the question. In addition, some contacts may not want to answer a question and this may also be noted.

At block 125, a computer processor may be used to evaluate the answer 205 from the contact to the at least one question 200 related to the purpose of the professional service provider. The evaluation may have several purposes. Part of the evaluation may be used to determine whether to ask more question and what the questions should be. For example as illustrated in FIGS. 2A and 2B, if a contact responds that they simply want to immediately contact the agent, a proper follow up question 210 may be “When are you available to meet?”

In another embodiment, a client may log into a content portal. The content portal may take into account the age, location, occupation, gender, topics, publisher sources, and interests of the client and may create a personalized content portal that automatically refreshes itself for the consumer. The content portal may have a variety of media and content which may be of interest to the user.

While in the content portal, the user may select a variety of articles or view a variety of media. Each of the articles or media may be tagged as having relevant information for the user and this data may be passed back to a central server or a professional services provider. The user activity in that portal translates to data that powers the lead prioritization engine. For example, an article on tax law changes may be taxed with “tax” while an article on IRAs may be tagged with “IRA.” These tags may be communicated back to the lead generation engine where a lead scoring engine for the professional service provider may rank the returned tags. As an example, a bankruptcy attorney may not be interested in leads for audit services but would be interested in someone reading an article about the latest audit changes.

The professional service advisors may also create different weights in the lead scoring engine for the type of material reviewed by the client such as through a content discovery portal. The content discovery portal may allow a professional services provider to adjust the weights and calculations used by the lead scoring engine to create a custom lead scoring engine. As an example, a client may log in and read articles on IRAs and different users may be more interested than others in providing information on IRAs. Thus, the lead scoring engine may be modified for the particular purposes of the professional service provider.

The lead scoring engine may be modified through an easy to operate portal where different “tags” may be given different weights where the weights relate to the interests of the professional service provider. For example, the portal may allow a professional service provider to move sliders or other easy to easy read indicators to represent the level of interest in the various items tagged in the articles.

In addition, the actions of the user may be monitored to further tailor content to be displayed in the future. For example, if a user solely reads articles on venture capital investments, additional articles on venture capital investments may be provided. By providing relevant and update content, clients may be enticed to return to the portal. In addition, professional service providers may receive additional insights into the needs of specific clients.

At block 130, a computer processor may be used to adjust the contact score based 310 on the evaluation of the answers from the contact related to the purpose of the professional service provider. Thus, the answer 205 may not be used just to guide the contact to the next appropriate question 210, the answer 205 may be graded as illustrated in FIGS. 3A-3C. As mentioned previously, the scores 310 may indicate the likelihood that a contact is ready and able to become a customer. Logically, the adjusted score may be stored in a memory and it may be reported to an analysis system. The scores in FIGS. 3A-3C are merely illustrative of one manner of placing the contacts into categories and are not meant to be limiting. The manner and variety of placing contacts into categories is virtually without limit as the desires of each professional service provider may be different. FIGS. 3A-3C are simply one example of how to separate contacts into categories and is not meant to be limiting.

In addition, the manner of scoring may be adjusted by a user. For example, net worth may be more valuable to some users while cash flow may be more important to other users. Thus, the scoring may be adjusted by the user to reflect the desired characteristics.

At block 135, a computer processor may be used to select a logical follow up question 210 based on the answer from the contact related to the purpose of the professional service provider. As illustrated in FIGS. 2A and 2B, there may be a logical progression of questions for contacts that visit the community. By posing and receiving answers to the questions, the professional service provider may be able to gauge the level of interest the contact has in using or meeting the professional service provider. By following the progression, contacts that have immediate interest may be contacted for appointments and contacts that may have interest in the future may be set up on a schedule for periodic follow-up calls. In addition, Of course, FIGS. 2A and 2B are just one illustration and the progression of questions may have a variety of paths depending on the questions, the answers and other relevant information about the contact. In some situations, the follow up question may be posed immediately and in other situation, the follow up question may be posed at a point in the future, such as three months, as an example.

At block 140, the logical follow up question that was selected may be displayed to the contact. As will be discussed further in the application, the display may be on a portable computing device, a desktop computing device or any device capable of displaying a question and receiving an answer in an electronic format. Further, as mentioned previously, the follow up questions in FIGS. 3A-3C are merely exemplary and may vary widely depending on the professional service provider.

At block 145, a, follow up answer may be received from the contact to the follow up question. At block 150, the follow-up answer from the contact to the follow up question may be evaluated. Referring to FIGS. 2A and 2B, in one aspect, the follow-up answer may direct the community to ask additional questions or to immediately communication with the contact. In some embodiments, the answers may indicate that the contact is not a useful contact and communication may end.

At block 155, the contact score 310 may be adjusted based on the evaluation of the follow-up answer to the follow up question. Again, referring to FIGS. 3A-3C, the answers 205 may indicate whether the contact is a likely client. Specifically, the score 310 may be adjusted upward for answers that indicate a contact is more likely to convert into a client and the score 310 may be adjusted downward to indicate that a contact is less likely to convert into a client 310. Logically, the adjusted score 310 may be stored in a memory and the score 310 may be reported to an analysis system. The score 310 may be used to direct current communications or future communications for the contact. For example, if a contact indicates that a large payment is due to be received in 4 months, it may be appropriate to be sure to communicate with the contact around four months from the present date. The scores in FIGS. 3A-3C are merely illustrative of one manner of placing the contacts into categories and are not meant to be limiting. The manner and variety of placing contacts into categories is virtually without limit as the desires of each professional service provider may be different. FIGS. 3A-3C are simply one example of how to separate contacts into categories and is not meant to be limiting.

Activities of a community member also may affect a score 310 for the community member. For example, if a community member is active in inviting several terrific fits to the community, the score 310 for the community member may rise. Similarly, if a member with a high score rarely visits the community, the score 310 may fall.

At block 160, the contact score 310 may be evaluated. Referring to FIGS. 3A-3C again, the answers from the initial question and any follow up questions may be assigned values and the values may be totaled. In one embodiment, the higher the total, the more likely that the contact will become a client. Of course, the scoring 310 may work in a variety of ways, all of which are contemplated. In addition, past experience may be used to adjust the scoring 310. As an example, if a contact indicated they were over 100 years old, it is unlikely they will be looking for a new investment professional service provider. Thus a further question may be added after asking if a person is retired (usually a positive indication to an investment professional service provider) to ask whether the user is over 100.

At block 165, it may be determined if the contact score 310 is over a threshold. The threshold may vary by investment professional service provider, by community or by a variety of other factors. For example, if the investment professional service provider is just starting, any contact may be worth pursuing. On the other hand, an extremely successful professional service provider may only follow up with contacts that have an enormous net worth. The professional service provider may adjust the threshold, it may be adjusted automatically or it may be set according to a standard.

At block 170, if the contact score 310 is over the threshold, a notification may be created for the professional service provider. The notification may take on a variety of forms. In some embodiments, an email may be communicated to the professional service provider that a likely potential client has accessed the community. In other embodiments, a notification may be communicated to the professional service provider and the professional service provider may be able to chat with the contact in real time. Other forms of communication are possible and are contemplated. The desired form of communicate the notification may be set by the professional service provider and there may be a default.

Members of the community may be able to invite others to be contacts in the community. For example, if a member of the community is especially happy, the member may desire to invite friends to join the community. In this way, the friends may also benefit from the insights from being part of the community. In some embodiments, a bonus may be provided to a member if a contact is invited and the bonus may increase in value as the value of the contact increases.

In yet a further embodiment, user contacts may be reviewed with permission from the user. The contacts may also be good fits in the community. Determining which contacts would be good fits may be a challenge. In one embodiment, data sources may be search using the contact information at hand. For example, a name may be used to try to find additional information about the contact. If there is a general location provided, the list of possible matches may be reduced. In some embodiment, simple searches of available network sites may be undertaken, such as entering a name as a query to a web search engine. In additional embodiments, the contact information may be submitted to a credit bureau or other centralized data source to better determine if the contact may be a decent potential client. All the data found may be reviewed by an algorithm that attempt to qualify whether the contact would be a good fit with the professional service provider.

In yet additional embodiments, APIs from social media web sites may be used to obtain additional contacts. The APIs from various social networking sites may provide links to additional contacts of friends from those social networking sites. From those links, additional information may be determined such as a location of the additional contact, a job title of the additional contact, the time in the work forces, recent promotions, recent retirements, friends of the additional contact, etc. The additional data may be used with research to help classify the additional contacts. For example, median income for zip codes is known. If a zip code for an additional contact can be determined, an estimate of the income of the additional contact may be made which may be used to help classify the additional contact. Similarly, if the additional contact has a title of “President” then that contact may be classified as a desirable additional contact. As yet another example, if an additional contact provides details of a vacation to an exotic location, then the additional contact may be classified as a desirable additional contact.

The additional data on additional contacts also may be used to encourage a contact to invite a desired additional contact to join the community. For example, on the display to a contact as part of the community where information of interest is displayed, a ribbon may be displayed on a side of the display with images of desired additional contacts that are in the social network of the contact. The image may be obtained through the API or through an electronic search. Simply by selecting the image, an invitation may be sent to the desired additional contact to join the community. As the contact view the content, names and/or images of desired additional contacts may appear, making it especially simple for a contact to invite an additional contact to join the community.

In another aspect, the additional data from the API may be used with additional outside sources to further classify the additional contacts. As an example, credit bureaus may provide useful financial information on the additional contacts such as a credit score, debt outstanding, investable assets, etc. Another useful outside source may be the electronic news which may report on relevant promotions, real estate transfers, lawsuits, arrests, that may provide useful addition data to help classify the additional contact. Any additional source of data may be appropriate to help classify the additional contact to provide an professional service provider a quick and efficient answer regarding whether it makes sense to invest time in pursuing the additional contact as a client.

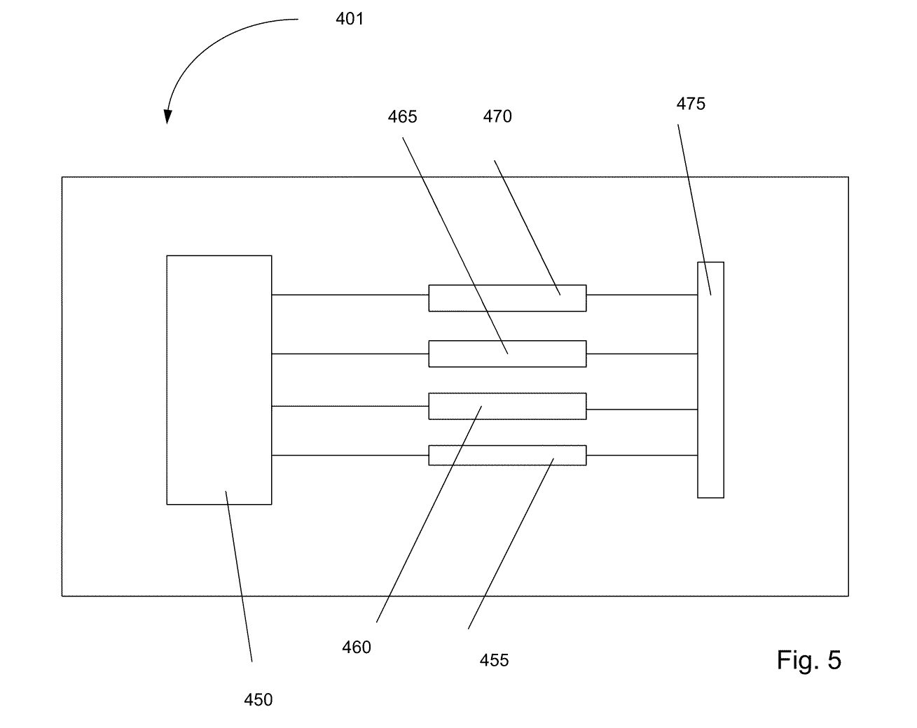

FIG. 4 may be a high level illustration of some of the elements a sample computing system that may be physically configured to implement the method. The computing system may be a dedicated computing device 441, a dedicated portable computing device 401, an application on the computing device 441, an application on the portable computing device 401 or a combination of all of these. FIG. 5 may be a high level illustration of a portable computing device 401 communicating with a remote computing device 441 but the application may be stored and accessed in a variety of ways. In addition, the application may be obtained in a variety of ways such as from an app store, from a web site, from a store WiFi system, etc. There may be various versions of the application to take advantage of the benefits of different computing devices, different languages and different API platforms.

In one embodiment, a portable computing device 401 may be a device that operates using a portable power source 455 such as a battery. The portable computing device 401 may also have a display 402 which may or may not be a touch sensitive display. More specifically, the display 402 may have a capacitance sensor, for example, that may be used to provide input data to the portable computing device 401. In other embodiments, an input pad 404 such as arrows, scroll wheels, keyboards, etc., may be used to provide inputs to the portable computing device 401. In addition, the portable computing device 401 may have a microphone 406 which may accept and store verbal data, a camera 408 to accept images and a speaker 410 to communicate sounds.

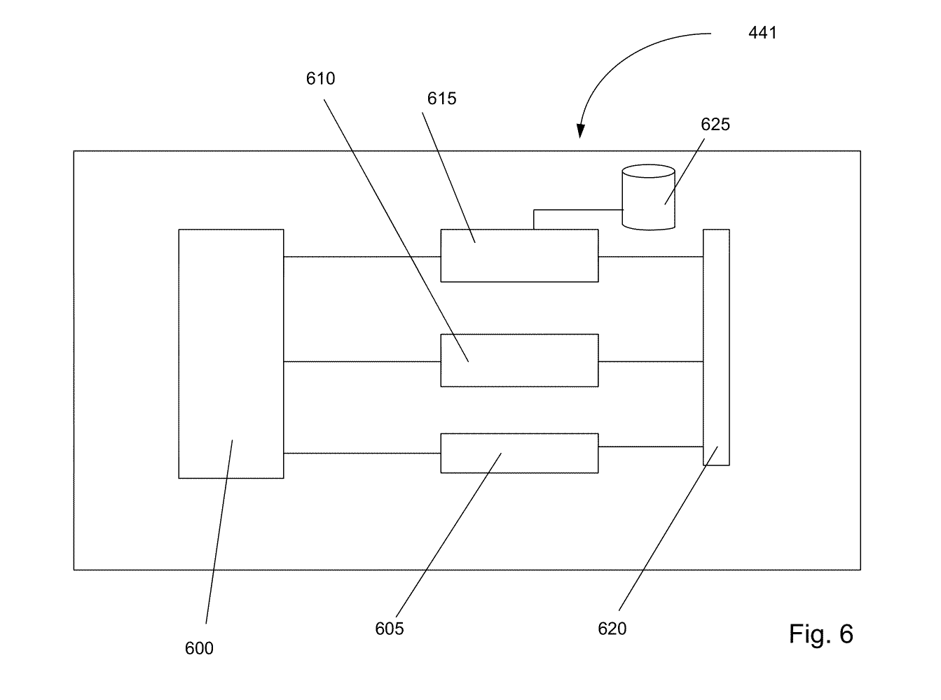

The portable computing device 401 may be able to communicate with a computing device 441 or a plurality of computing devices 441 that make up a cloud of computing devices 411. The portable computing device 401 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 441 or may be through a communication network 421 such as cellular service, through the Internet, through a private network, through Bluetooth, etc. FIG. 5 may be a simplified illustration of the physical elements that make up a portable computing device 401 and FIG. 6 may be a simplified illustration of the physical elements that make up a server type computing device 441.

FIG. 5 may be a sample portable computing device 401 that is physically configured according to be part of the system. The portable computing device 401 may have a processor 450 that is physically configured according to computer executable instructions. It may have a portable power supply 455 such as a battery which may be rechargeable. It may also have a sound and video module 460 which assists in displaying video and sound and may turn off when not in use to conserve power and battery life. The portable computing device 401 may also have volatile memory 465 and non-volatile memory 470. There also may be an input/output bus 475 that shuttles data to and from the various user input devices such as the microphone 406, the camera 408 and other inputs 402, etc. It also may control of communicating with the networks, either through wireless or wired devices. Of course, this is just one embodiment of the portable computing device 401 and the number and types of portable computing devices 401 is limited only by the imagination.

The physical elements that make up the remote computing device 441 may be further illustrated in FIG. 6. At a high level, the computing device 441 may include a digital storage such as a magnetic disk, an optical disk, flash storage, non-volatile storage, etc. Structured data may be stored in the digital storage such as in a database. The server 441 may have a processor 600 that is physically configured according to computer executable instructions. It may also have a sound and video module 605 which assists in displaying video and sound and may turn off when not in use to conserve power and battery life. The server 441 may also have volatile memory 610 and non-volatile memory 615.

The database 625 may be stored in the memory 610 or 615 or may be separate. The database 625 may also be part of a cloud of computing device 441 and may be stored in a distributed manner across a plurality of computing devices 441. There also may be an input/output bus 620 that shuttles data to and from the various user input devices such as the microphone 406, the camera 408, the inputs 402, etc. The input/output bus 620 also may control of communicating with the networks, either through wireless or wired devices. In some embodiments, the application may be on the local computing device 401 and in other embodiments, the application may be remote 441. Of course, this is just one embodiment of the server 441 and the number and types of portable computing devices 441 is limited only by the imagination.

In application, the system and method may assist professional service providers sift out contacts in a way that saves time and is significantly more efficient than previous methods. In addition, contacts will be graded and better contacts may be treated differently than worse contacts. Further, the members of the various communities may invite others to join the community, which will bring additional members that will graded by the system, further saving time and resulting in increased efficiency.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

1. A method of evaluating contacts for an professional service provider comprising
Using a processor to receive a sign on from a contact
Using a computer processor to evaluate the manner of which the contact signed in;
Using a computer processor to adjust a contact classification on the evaluation of the manner of which the contact signed in;
Displaying at least one question to the contact related to a purpose of the professional service provider;
Receiving an answer from the contact to the question;
Using a computer processor to evaluate the answer from the contact to the at least one question related to the purpose of the professional service provider;
Using a computer processor to adjust the contact classification based on the evaluation of the answers from the contact related to the purpose of the professional service provider;
Using a computer processor to select a logical follow up question based on the answer from the contact related to the purpose of the professional service provider;
Displaying the logical follow up question selected to the contact;
Receiving a follow up answer from the contact to the follow up question;
Using a computer processor to evaluate the follow-up answer from the contact to the follow up question;
Using a computer processor to adjust the contact classification based on the evaluation of the follow-up answer to the follow up question;
Using a computer processor to evaluate the contact classification;
Using a computer processor to determine if the contact classification is over a threshold; and
If the contact classification is over the threshold, creating a notification for the professional service provider.

2. The method of claim 1, wherein the contact classification is based on the contact classification score.

3. The method of claim 1, further comprising adjusting the classification upward for answers that indicate a contact is more likely to convert into a client and adjusting the classification downward to indicate that a contact is less likely to convert into a client.

4. The method of claim 1, wherein using a computer processor to evaluate the manner of which the contact signed in further comprises determining:
whether the user signed in using an API,
whether the user signed in without using an API,
whether the user was invited by a client,
whether the user was invited by a non-client;
whether the user reviewed the first content piece,
whether the user shared the content piece,
whether the user invited a friend, and
whether the user is a pre-existing prospect of the professional service provider.

5. The method of claim 1, further comprising storing the adjusted classification in a memory and reporting the classification to an analysis system.

6. The method of claim 1, further comprising allowing the contact to invite others to sign in.

7. The method of claim 1, further comprising displaying at least one article related to the purpose of the professional service provider.

8. The method of claim 1, further comprising allowing the professional service provider to have a plurality of communities where each community has a specific focus.

9. The method of claim 1, further comprising supplying the professional service provider with content related to the specific focus of each community.

10. The method of claim 1, further comprising reviewing user contacts, determining which user contacts would be appropriate to be invited to the community and suggesting that the user invite the determined user contacts to the community.

11. The method of claim 10, wherein determining which user contacts would be appropriate to be invited to the community further comprises
searching for additional data of the user contacts using available data on the user contacts;
analyzing the available data and the additional data on the user contacts to determine if the user contact would be appropriate to be invited to the community.

12. The method of claim 1, further comprising aggregating activities for the user on the communities of an professional service provider and adjusting the classification for the user based on the activities of the user.

13. The method of claim 1, wherein the one question to the contact related to a purpose of the professional service provider attempts to determine how likely is the contact to require services from the professional service provider.

14. The method of claim 1, wherein the follow-up question further comprise questions to further identify how likely is the contact to require services from the professional service provider.

15. The method of claim 1, wherein if the contact classification is over a threshold, asking to schedule a meeting with the contact.
